(19) United States
(12) Patent Application Publication
(10) Pub. No.: US 2023/0393903 A1
(43) Pub. Date: Dec. 7, 2023

(54) METHOD AND SYSTEM FOR MANAGING REPRODUCIBLE MACHINE LEARNING WORKFLOWS

(71) Applicant: Flipkart Internet Private Limited, Bengaluru (IN)

(72) Inventors: Mayank Kumar, Karnataka (IN); Naidu Kvm, Karnataka (IN); Piyush Vyas, Karnataka (IN); Suvigya Vijay, Karnataka (IN)

(21) Appl. No.: 18/156,643

(22) Filed: Jan. 19, 2023

(30) Foreign Application Priority Data
Jun. 1, 2022 (IN) 202241031521

(51) Int. Cl. G06F 9/50; G06F 9/48

(52) U.S. Cl. CPC G06F 9/5077; G06F 9/4881

(57) ABSTRACT

A method and system for managing reproducible machine learning workflows are disclosed. The method includes receiving input comprising abstract data sets, and transforming abstract data sets into abstract data types. The method includes generating abstract pipelines using abstract data types, and implementing abstract pipelines as packages. The method includes configuring packages as map of key-value pairs comprising keys, and storing configured packages in database. The method includes generating execution plan by converting abstract pipelines from the configured packages into concrete pipelines. Further, method includes transmitting execution plan to orchestrator to merge individual concrete pipelines into dataset dependency graph, and to mark tasks in dataset dependency graph. The method includes executing tasks as cluster, by calling appropriate command, and obtaining predictions from different models or same model with different hyperparameters to provide meta construct, upon executing tasks as cluster. The method includes outputting modified DAG comprising tasks mapped to configuration.

### RELATED APPLICATION

The present application claims the benefit of and priority from Indian Patent Application No. 202241031521, filed Jun. 1, 2022, the disclosure of which is incorporated herein by reference in its entirety

### FIELD OF INVENTION

The embodiments of the present disclosure generally relate to a field of machine learning. More particularly, the present disclosure relates to a method and a system for managing reproducible machine learning workflows.

### BACKGROUND

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of the prior art.

Generally, machine learning can be a central part of many businesses and organizations impacting society and administration. The fast-paced growth and adoption of machine learning at every level may have created a technical drawback in the systems used for development and deployment. Further, the development and deployment of complex machine learning solutions may demand much agility in business requirement changes, data sets, feature engineering, models, validation, ensembles, deployment, and monitoring. Such solutions need to provide reproducible runs, standardization, re-usability, systematic version management, and the ability to debug at a fine granularity to be usable by large organizations. Additionally, as machine learning projects and workflows become more sophisticated and complex, there is a need for a workflow manager and task orchestrator that addresses nuances more specific and critical to machine learning. Though there are many workflow managers, most of them are generic workflow managers that primarily treat a workflow as a dependency graph and orchestrate the tasks using available resources.

Conventional systems may have addressed a few needs, such as multi-language support, declarative workflows, and multi-backend support. However, the conventional systems may need some other resources to address the needs, or the conventional systems may not address all the needs. Further, the conventional systems may fall short of addressing the primary needs of machine learning workflows. Some of which are based on anecdotal evidence, determining coarse/fine-grained pipeline characteristics, analyzing opportunities to make the pipelines more efficient, efficient data preparation, optimizing query plans, dealing with streaming data, sharing of computation, materializing, reusing, and provenance for reproducibility and debugging.

Several conventional ML systems may have addressed one or more of the aforementioned issues. Most of the upcoming ML systems may employ a declarative programming approach to compose ML pipelines and focus on metadata tracking for workflow updates and reproducibility. These systems empirically have specific backend requirements. Some systems have specific language requirements as well. For ease of debugging, conventional systems have focused on none-to-production-only debugging environments, limiting data scientists' ability to debug the workflows efficiently. Other systems/libraries tackle specific ML development lifecycle problems by providing experiment tracking and visualization, allowing multiple backends for workflow orchestration, and aiming at running complex batch jobs. The conventional systems provide accelerated ML development and deployment by standardized definitions, reproducibility, and debugging. However, the conventional systems may not compute caching, restricts users in the number of languages available, and the backend may be tied to one or more web services.

Therefore, there is a need for a method and a system for solving the shortcomings of the current technologies, by providing a method and a system for managing machine learning workflows.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may be for managing reproducible machine learning workflows.

It is an object of the present disclosure to provide a method and a system for managing reproducible machine learning workflows.

It is an object of the present disclosure to provide an experiment agility based on caching executed task outputs to help users do similar experiments quickly.

It is an object of the present disclosure to provide a platform/language agility by running pipelines while being agnostic to language.

It is an object of the present disclosure to provide a Machine Learning (ML) meta construct such as vertical/horizontal stacking, hyperparameter tuning, back casting (for time series), and the like.

It is an object of the present disclosure to provide a reproducibility and data standardization, by creating, maintaining, deleting the data generated at various stages, and maintaining implementation versions to track and reproduce results.

It is an object of the present disclosure to provide ease of debugging by allowing the users to modify a part of some tasks and run dependent tasks only instead of running the whole pipeline from the beginning. Even for the produced pipelines, logs and the intermediate data are available to users for debugging.

It is an object of the present disclosure to provide continuous integration and deployment, based on checking the feasibility and testing automatically before merging new changes or allowing reverting back to the previous deployment in case of any issues.

In an aspect, the present disclosure provides a method for managing reproducible machine learning workflows. The method includes receiving an input comprising abstract data sets. Each abstract data set comprises an identifier and a specification as a one-layer set of key-value pairs. Further, the method includes transforming the received abstract data sets into one or more abstract data types. Each abstract data type comprises a set of parameters specified as key-value pairs of variable names and associated abstract data types along with a map of input abstract data sets and output abstract data sets. Furthermore, the method includes generating one or more abstract pipelines using one or more abstract data types. The one or more abstract pipelines are machine learning workflows. Further, the one or more abstract pipelines comprise similar specifications of the abstract data types and a Directed Acyclic Graph (DAG). Further, the method includes implementing the one or more abstract pipelines as one or more packages. The one or more packages comprise pre-defined names and, the one or more packages are systematically imported. Furthermore, the method includes configuring one or more packages as a map of key-value pairs comprising keys. The keys in the configuration are a superset of keys in the set of parameters. Further, the method includes storing the configured one or more packages in a database. The one or more packages are stored upon checking in a repository and storing locally as files. Furthermore, the method includes generating an execution plan by converting the one or more abstract pipelines from the configured one or more packages into one or more concrete pipelines. Further, the method includes transmitting the execution plan to an orchestrator to merge individual one or more concrete pipelines into a dataset dependency graph, and to mark one or more tasks in the dataset dependency graph. Additionally, the method includes executing the one or more tasks as a cluster, by calling an appropriate command. Further, the method includes obtaining one or more predictions from different models or same model with different hyperparameters to provide a meta construct, upon executing the one or more tasks as the cluster. Furthermore, the method includes outputting a modified DAG comprising the one or more tasks mapped to the configuration. The mapped one or more tasks are combined towards the end.

In an embodiment, the abstract data sets, the one or more abstract pipelines comprises the specification, and wherein the one or more concrete pipelines comprise implementation.

In an embodiment, the configuration specifies a mapping of each one or more abstract data types to implementation of the one or more abstract pipelines.

In an embodiment, each implementation of the one or more abstract pipelines as one or more packages inherits a base class to provide inherent access to the set of parameters and the abstract data sets and handle storage of the abstract data sets.

In an embodiment, each transformation of the received abstract data sets into the one or more abstract data types comprises metadata. The metadata comprises at least one of, a Uniform Resource Identifier (URI), an abstract transform name, an affinity, versions, and schemas for the abstract data sets.

In an embodiment, the one or more abstract pipelines are an extension of the transformation.

In an embodiment, the DAG comprises nodes, wherein the nodes are the transformation specified by a name mapped to the one or more abstract data types.

In an embodiment, the meta construct comprises at least one of a workflow specification, a mapper function, and a combiner function. The mapper function is to generate a list of configurations for the workflow specification, and the combiner function comprises receiving a list of runs for a list of configurations and generating an output.

In an embodiment, the one or more concrete pipelines comprise a dataset dependency map which comprises a dependency of concrete data types to concrete datasets of parent concrete data types, and a task definition map with information of concrete data types.

In an embodiment, the orchestrator comprises three components, which comprises a server to actively listen to commands from other components and the client, to maintain a queue for submitting the one or more abstract pipelines, completed tasks, to maintain a list of machines in the clusters, a session manager to maintain the dependency graph and task information, a scheduler to connect with spawners that run the tasks.

In an embodiment, upon executing one or more tasks as the cluster, the orchestrator transmits task information to a spawner. The spawner receives task information from the orchestrator and calls an executor depending on the task information. The executor executes and saves the output and signals the completion to the spawner. The spawner signals back to the orchestrator.

In another aspect, the present disclosure provides a system for managing reproducible machine learning workflows. The system receives an input comprising abstract data sets. Each abstract data set comprises an identifier and a specification as a one-layer set of key-value pairs. Further, the system transforms the received abstract data sets into one or more abstract data types. Each abstract data type comprises a set of parameters specified as key-value pairs of variable names and associated abstract data types along with a map of input abstract data sets and output abstract data sets. Furthermore, the system generates one or more abstract pipelines using the one or more abstract data types. The one or more abstract pipelines are machine learning workflows. The one or more abstract pipelines comprise similar specifications of the abstract data types and a Directed Acyclic Graph (DAG). Furthermore, the system implements the one or more abstract pipelines as one or more packages. The one or more packages comprise pre-defined names and one or more packages are imported systematically. Furthermore, the system configures the one or more packages as a map of key-value pairs comprising keys. The keys in the configuration are a superset of keys in the set of parameters. Further, the system stores the configured one or more packages in a database. The one or more packages are stored upon checking in a repository and storing locally as files. Furthermore, the system generates an execution plan by converting the one or more abstract pipelines from the configured one or more packages into one or more concrete pipelines. Further, the system transmits the execution plan to an orchestrator to merge individual one or more concrete pipelines into a dataset dependency graph, and to mark one or more tasks in the dataset dependency graph. Furthermore, the system executes the one or more tasks as a cluster, by calling an appropriate command. Further, the system obtains one or more predictions from different models or same model with different hyperparameters to provide a meta construct, upon executing the one or more tasks as the cluster. Additionally, the system outputs a modified DAG comprising the one or more tasks mapped to the configuration, wherein the mapped one or more tasks are combined towards the end.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that the invention of such drawings includes the invention of electrical components, electronic components, or circuitry commonly used to implement such components.

FIG. 1 illustrates an exemplary block diagram representation of a network architecture implementing a proposed system for managing reproducible machine learning workflows, according to embodiments of the present disclosure.

FIG. 2 illustrates an exemplary detailed block diagram representation of the proposed system, according to embodiments of the present disclosure.

FIG. 3A illustrates an exemplary flow diagram representation of method of creating execution plan, according to embodiments of the present disclosure.

FIG. 3B illustrates an exemplary block diagram representation of orchestrator components, according to embodiments of the present disclosure.

FIG. 3C illustrates exemplary pipeline diagram for map combine to select best scaling method, according to embodiments of the present disclosure.

FIG. 4 illustrates a flow chart depicting a method of managing reproducible machine learning workflows, according to embodiments of the present disclosure.

FIG. 5 illustrates a hardware platform for the implementation of the disclosed system according to embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provide a method and a system for managing reproducible machine learning workflows. The present disclosure provides experiment agility based on caching executed task outputs to help users do similar experiments quickly. The present disclosure provides a platform/language agility by running pipelines while being agnostic to language. The present disclosure provides a Machine Learning (ML) meta construct such as vertical/horizontal stacking, hyperparameter tuning, back casting (for time series), and the like. The present disclosure provides a reproducibility and data standardization, by creating, maintaining, deleting the data generated at various stages, and maintaining implementation versions to track and reproduce results. The present disclosure provides ease of debugging by allowing the users to modify a part of some tasks and run dependent tasks only instead of running the whole pipeline from the beginning. Even for the produced pipelines, logs and the intermediate data are available to users for debugging. The present disclosure provides continuous integration and deployment, based on checking the feasibility and testing automatically before merging new changes or allowing reverting back to the previous deployment in case of any issues.

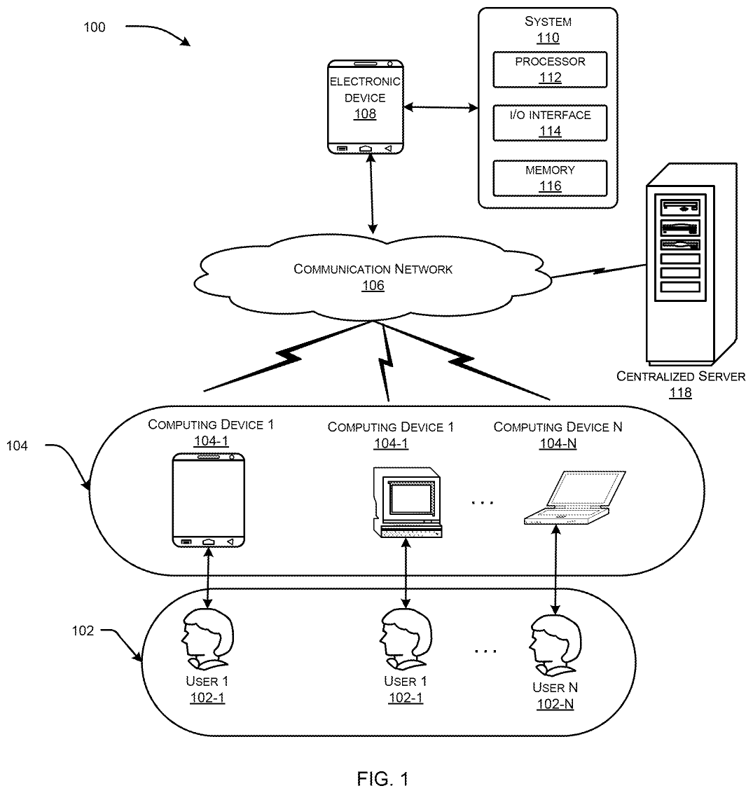

FIG. 1 illustrates an exemplary block diagram representation of a network architecture 100 implementing a proposed system 110 (also referred as a workflow management system 110) for managing reproducible machine learning workflows, according to embodiments of the present disclosure. The network architecture 100 may include the system 110, an electronic device 108, and a centralized server 118. The system 110 may be connected to the centralized server 118 via a communication network 106. The centralized server 118 may include, but is not limited to, a stand-alone server, a remote server, a cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable of transferring data between entities of that network such as, but are not limited to, a carrier network including circuit-switched network, a public switched network, a Content Delivery Network (CDN) network, a Long-Term Evolution (LTE) network, a New Radio (NR), a Global System for Mobile Communications (GSM) network and a Universal Mobile Telecommunications System (UMTS) network, an Internet, intranets, Local Area Networks (LANs), Wide Area Networks (WANs), mobile communication networks, combinations thereof, and the like.

The system 110 may be implemented by way of a single device or a combination of multiple devices that may be operatively connected or networked together. For example, the system 110 may be implemented by way of a standalone device such as the centralized server 118, and the like, and may be communicatively coupled to the electronic device 108. In another example, the system 110 may be implemented in/associated with the electronic device 108. In yet another example, the system 110 may be implemented in/associated with respective computing device 104-1, 104-2, . . . , 104-N(individually referred to as computing device 104, and collectively referred to as computing devices 104), associated with one or more user 102-1, 102-2, . . . , 102-N (individually referred to as the user 102, and collectively referred to as the users 102). In such a scenario, the system 110 may be replicated in each of the computing devices 104. The users 102 may be a user of an electronic commerce (e-commerce) platform, a hyperlocal platform, a super-mart platform, a media platform, a service providing platform, a social networking platform, a messaging platform, a bot processing platform, a virtual assistance platform, an artificial intelligence platform, and the like. In some instances, the user 102 may include an entity/administrator. The electronic device 108 may be at least one of, an electrical, an electronic, an electromechanical, and a computing device. The electronic device 108 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, server, and the like. The system 110 may be implemented in hardware or a suitable combination of hardware and software. The system 110 or the centralized server 118 may be associated with entities (not shown). The entities may include, but are not limited to, an e-commerce company, a company, an outlet, a manufacturing unit, an enterprise, a facility, an organization, an educational institution, a secured facility, and the like.

Further, the system 110 may include a processor 112, an Input/Output (I/O) interface 114, and a memory 116. The Input/Output (I/O) interface 114 on the system 110 may be used to receive user inputs, from one or more computing devices 104-1, 104-2, . . . , 104-N (collectively referred to as the computing devices 104 and individually referred to as computing device 104) associated with one or more users 102 (collectively referred as users 102 and individually referred as user 102).

Further, system 110 may also include other units such as a display unit, an input unit, an output unit, and the like, however the same are not shown in the FIG. 1, for the purpose of clarity. Also, in FIG. 1 only few units are shown, however, the system 110 or the network architecture 100 may include multiple such units or the system 110/network architecture 100 may include any such numbers of the units, obvious to a person skilled in the art or as required to implement the features of the present disclosure. The system 110 may be a hardware device including the processor 112 executing machine-readable program instructions to manage reproducible machine learning workflows. Execution of the machine-readable program instructions by the processor 112 may enable the proposed system 110 to manage reproducible machine learning workflows. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors. The processor 112 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor 112 may fetch and execute computer-readable instructions in the memory 116 operationally coupled with the system 110 for performing tasks such as data processing, input/output processing, and/or any other functions. Any reference to a task in the present disclosure may refer to an operation being or that may be performed on data.

In the example that follows, assume that a user 102 of the system 110 desires to improve/add additional features for managing reproducible machine learning workflows. In this instance, the user 102 may include an administrator of a website, an administrator of an e-commerce site, an administrator of a social media site, an administrator of an e-commerce application/social media application/other applications, an administrator of media content (e.g., television content, video-on-demand content, online video content, graphical content, image content, augmented/virtual reality content, metaverse content), among other examples, and the like. The system 110 when associated with the electronic device 108 or the centralized server 118 may include, but are not limited to, a touch panel, a soft keypad, a hard keypad (including buttons), and the like.

In an embodiment, the system 110 may receive an input comprising abstract data sets. Each abstract data set may include an identifier and a specification as a one-layer set of key-value pairs. In an embodiment, the system 110 may transform the received abstract data sets into one or more abstract data types. Each abstract data type may include a set of parameters specified as key-value pairs of variable names and associated abstract data types along with a map of input abstract data sets and output abstract data sets. In an embodiment, abstract data sets, the one or more abstract pipelines may include the specification. Each transformation of the received abstract data sets into the one or more abstract data types may include metadata. Further, the metadata includes at least one of, a Uniform Resource Identifier (URI), an abstract transform name, an affinity, versions, schemas for the abstract data sets, and the like.

In an embodiment, the system 110 may generate one or more abstract pipelines using the one or more abstract data types. In an embodiment, the one or more abstract pipelines are machine learning workflows. The one or more abstract pipelines may include similar specifications of the abstract data types and a Directed Acyclic Graph (DAG). The one or more abstract pipelines may be an extension of the transformation. The DAG may include nodes. The nodes may be the transformation specified by a name mapped to the one or more abstract data types. In an embodiment, the system 110 may implement the one or more abstract pipelines as one or more packages. The one or more packages may include pre-defined names and are imported systematically.

In an embodiment, the system 110 may configure the one or more packages as a map of key-value pairs comprising keys. The keys in the configuration may be a superset of keys in the set of parameters. The configuration may specify a mapping of each one or more abstract data types to implementation of the one or more abstract pipelines. Each implementation of the one or more abstract pipelines as one or more packages may inherit a base class to provide inherent access to the set of parameters and the abstract data sets and handle storage of the abstract data sets.

In an embodiment, the system 110 may store the configured one or more packages in a database. The one or more packages may be stored upon checking in a repository and storing locally as files. In an embodiment, the system 110 may generate an execution plan by converting the one or more abstract pipelines from the configured one or more packages into one or more concrete pipelines. The one or more concrete pipelines may include implementation.

In an embodiment, the system 110 may transmit the execution plan to an orchestrator to merge individual one or more concrete pipelines into a dataset dependency graph, and to mark one or more tasks in the dataset dependency graph. The one or more concrete pipelines may include a dataset dependency map which include a dependency of concrete data types to concrete datasets of parent concrete data types, and a task definition map with information on concrete data types. the orchestrator may include three components. The three components include, a server to actively listen to commands from other components and the client, to maintain a queue for the one or more abstract pipelines, completed tasks, to maintain a list of machines in the clusters, a session manager to maintain the dependency graph and task information, a scheduler to connect with spawners that run the tasks, and the like.

In an embodiment, upon executing the one or more tasks as the cluster, the orchestrator may transmit task information to a spawner. The spawner may receive task information from the orchestrator and calls an executor depending on the task information. The executor may execute and save the output and signals the completion to the spawner. The spawner may signal back to the orchestrator.

In an embodiment, the system 110 may execute the one or more tasks as a cluster, by calling an appropriate command. In an embodiment, the system 110 may obtain one or more predictions from different models or same model with different hyperparameters to provide a meta construct, upon executing the one or more tasks as the cluster. The meta construct may include at least one of a workflow specification, a mapper function, a combiner function, and the like. In an embodiment, the mapper function may be used to generate a list of configurations for the workflow specification. The combiner function may include receiving a list of runs for a list of configurations and generating an output. In an embodiment, the system 110 may output a modified DAG comprising one or more tasks mapped to the configuration. The mapped one or more tasks are combined towards the end.

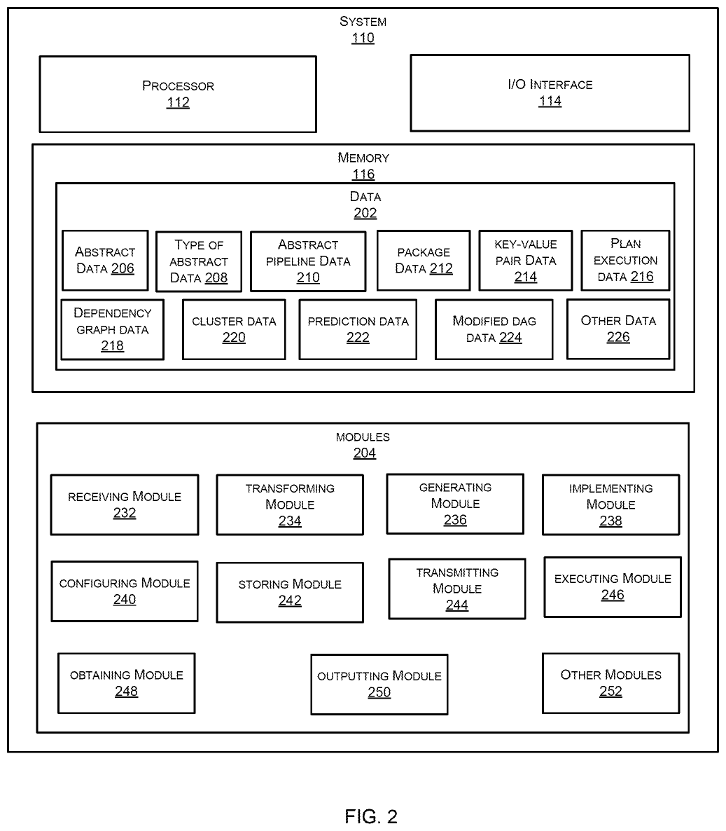

FIG. 2 illustrates an exemplary detailed block diagram representation of the proposed system 110, according to embodiments of the present disclosure. The system 110 may include the processor 112, the Input/Output (I/O) interface 114, and the memory 116. In some implementations, the system 110 may include data 202, and modules 204. As an example, the data 202 may be stored in the memory 116 configured in the system 110 as shown in the FIG. 2. In an embodiment, the data 202 may include abstract data 206, type of abstract data 208, abstract pipeline data 210, package data 212, key-value pair data 214, plan execution data 216, dependency graph data 218, cluster data 220, prediction data 222, modified DAG data 224, and other data 226. In an embodiment, the data 202 may be stored in the memory 116 in the form of various data structures. Additionally, the data 202 can be organized using data models, such as relational or hierarchical data models. The other data 218 may store data, including temporary data and temporary files, generated by the modules 204 for performing the various functions of the system 110.

In an embodiment, the modules 204, may include a receiving module 232, a transforming module 234, a generating module 236, an implementing module 238, a configuring module 240, a storing module 242, a transmitting module 244, an executing module 246, an obtaining module 248, an outputting module 350, and other modules 352.

In an embodiment, the data 202 stored in the memory 116 may be processed by the modules 204 of the system 110. The modules 204 may be stored within the memory 116. In an example, the modules 204 communicatively coupled to the processor 112 configured in the system 110, may also be present outside the memory 116, as shown in FIG. 2, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 232 may receive an input comprising abstract data sets. Each abstract data set may include an identifier and a specification as a one-layer set of key-value pairs. The received abstract data sets may be stored as the abstract data 206. In an embodiment, the transforming module 234 may transform the received abstract data sets into one or more abstract data types. The transformed one or more abstract data types may be stored as the type of abstract data 208. Each abstract data type may include a set of parameters specified as key-value pairs of variable names and associated abstract data types along with a map of input abstract data sets and output abstract data sets. In an embodiment, abstract data sets, the one or more abstract pipelines may include the specification. Each transformation of the received abstract data sets into the one or more abstract data types may include metadata. Further, the metadata includes at least one of, a Uniform Resource Identifier (URI), an abstract transform name, an affinity, versions, schemas for the abstract data sets, and the like.

In an embodiment, the generating module 236 may generate one or more abstract pipelines using the one or more abstract data types. The generated one or more abstract pipelines may be stored as the abstract pipeline data 210. In an embodiment, the one or more abstract pipelines are machine learning workflows. The one or more abstract pipelines may include similar specifications of the abstract data types and a Directed Acyclic Graph (DAG). The one or more abstract pipelines may be an extension of the transformation. The DAG may include nodes. The nodes may be the transformation specified by a name mapped to the one or more abstract data types. In an embodiment, the implementing module 238 may implement the one or more abstract pipelines as one or more packages. The one or more packages may include pre-defined names and are imported systematically.

In an embodiment, the configuring module 240 may configure the one or more packages as a map of key-value pairs comprising keys. The configured one or more packages may be stored as the package data 212. The map of key-value pairs comprising keys may be stored as the key-value pair data 214. The keys in the configuration may be a superset of keys in the set of parameters. The configuration may specify a mapping of each one or more abstract data types to implementation of the one or more abstract pipelines. Each implementation of the one or more abstract pipelines as one or more packages may inherit a base class to provide inherent access to the set of parameters and the abstract data sets and handle storage of the abstract data sets.

In an embodiment, the storing module 242 may store the configured one or more packages in a database. The one or more packages may be stored upon checking in a repository and storing locally as files. In an embodiment, the generating module 236 may generate an execution plan by converting the one or more abstract pipelines from the configured one or more packages into one or more concrete pipelines. The generated execution plan may be stored as the plan execution data 216. The one or more concrete pipelines may include implementation.

In an embodiment, the transmitting module 244 may transmit the execution plan to an orchestrator to merge individual one or more concrete pipelines into a dataset dependency graph, and to mark one or more tasks in the dataset dependency graph. The merged individual one or more concrete pipelines into the dataset dependency graph may be stored as the dependency graph data 218. The one or more concrete pipelines may include a dataset dependency map which include a dependency of concrete data types to concrete datasets of parent concrete data types, and a task definition map with information on concrete data types. the orchestrator may include three components. The three components include a server to actively listen to commands from other components and the client, to maintain a queue for the one or more abstract pipelines, completed tasks, to maintain a list of machines in the clusters, a session manager to maintain the dependency graph and task information, a scheduler to connect with spawners that run the tasks, and the like.

In an embodiment, upon executing the one or more tasks as the cluster, the orchestrator may transmit task information to a spawner. The spawner may receive task information from the orchestrator and calls an executor depending on the task information. The executor may execute and save the output and signals the completion to the spawner. The spawner may signal back to the orchestrator.

In an embodiment, the executing module 246 may execute the one or more tasks as a cluster, by calling an appropriate command. The clusters may be stored as the cluster data 220. In an embodiment, the obtaining module 248 may obtain one or more predictions from different models or same model with different hyperparameters to provide a meta construct, upon executing the one or more tasks as the cluster. The one or more predictions may be stored as the prediction data 222. The meta construct may include at least one of a workflow specification, a mapper function, a combiner function, and the like. In an embodiment, the mapper function may be used to generate a list of configurations for the workflow specification. The combiner function may include receiving a list of runs for a list of configurations and generating an output. In an embodiment, the outputting module 350 may output a modified DAG comprising one or more tasks mapped to the configuration. The modified DAG comprising one or more tasks may be stored as the modified DAG data 224. The mapped one or more tasks are combined towards the end.

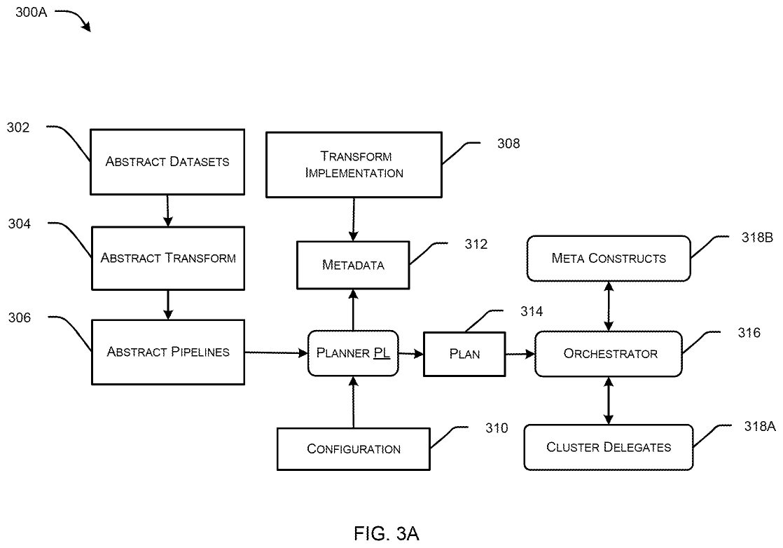

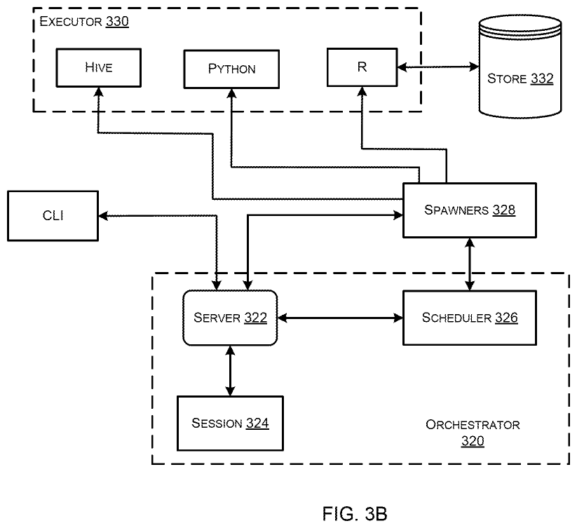

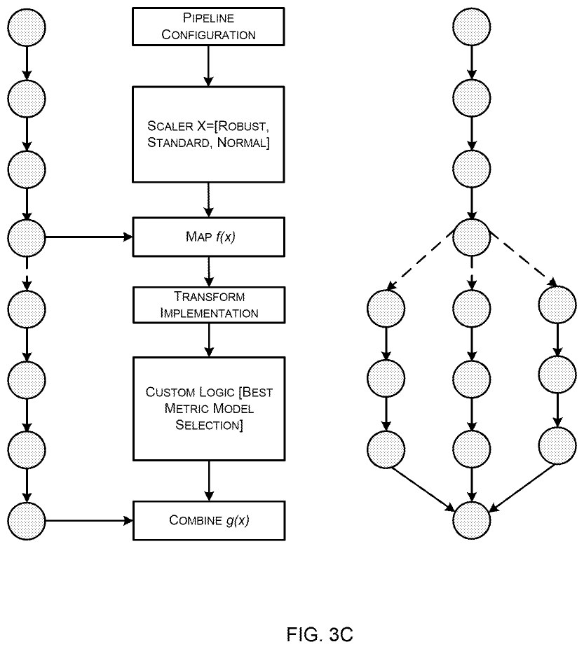

FIG. 3A illustrates an exemplary flow diagram representation of method 300A of creating an execution plan, according to embodiments of the present disclosure.

At step 302, the method 300A may include receiving, by the processor 112, the input comprising abstract data sets. Each abstract dataset may be defined by an identifier and a specification as a simple one-layer set of key-value pairs. Each key-value pair defines the name and type of that variable. The data types may include, but is not limited to, int, float, string, and custom data types such as data frame, image, model, and the like. Hence, the abstract dataset may be denoted as shown in equation 1 below:

D=<v→tv> Equation 1

In the above equation 1, the variable ‘t’ may be a data type, ‘v’ may be a variable name, and ‘< >’ may denote an associative map. For example, the abstract dataset may include a dataset as ‘housing_data’, and the ‘housing_data’ may include one data frame variable named data and one integer variable named ‘row_count’. While the dataset ‘housing_model’ includes only one variable model which has to be saved in ‘pickle/hdf5’ format.

At step 304, the method 300A may include transforming, by the processor 112, the received abstract data sets into one or more abstract data types. Each abstract transform may be defined as a set of parameters, specified as key-value pairs of variable names and associated data types (basic data types like int, float, string), along with a map of input abstract datasets and output abstract datasets. Such transform may be as shown in below equation 2:

$$T = < \qquad Equation 2$$

$$params : < v ⟶ tv > ;$$

$$in : < i ⟶ Di > ;$$

$$out : < o ⟶ Do >$$

$$>$$

In the above equation 2, T.params. v, T.in. i, T.out. o may be respective variables (and accordingly their types). For example, the abstract transform may include a transform type ‘train_usa_housing’ which requires parameters of type string, Boolean, integer data types, and accepts ‘housing_split_data’ dataset as input variable ‘in_var,’ while generating the output ‘out_var’ corresponding to the ‘housing_model’ dataset.

At step 306, the method 300A may include generating, by the processor 112, one or more abstract pipelines using the one or more abstract data types. The abstract pipelines may be conceptually an extension of abstract the transforms. The abstract pipelines may include the same specification as abstract transform and additionally a Directed Acyclic Graph (DAG). Further, nodes of the DAG may be the abstract transforms specified by a name mapped to a transform type. The edges capturing the dependency graphs may be specified as mapping the datasets involved in the abstract transforms. Each input of a given abstract transform may be an output from another abstract transform. Hence dependencies (also referred herein as ‘deps’) may be specified as a map of input of each abstract transform to some output of abstract transform dataset. Accordingly, an abstract pipeline can be specified as shown in below equation 3:

$$P = < \qquad Equation 3$$

$$params : < v ⟶ tv > ;$$

$$in : < i ⟶ Di > ;$$

$$out : < o ⟶ Do > ;$$

$$transforms : [ T 1 … Tn ] ;$$

$$deps : < Ti \cdot in \cdot u ⟶ {T}_{j} \cdot out \cdot v >$$

$$>$$

For example, the abstract pipeline may include ‘house_price_pred_pipeline’ It contains list of abstract transforms under variable tasks while variable deps may include the information regarding which variable of an abstract transform is being passed as the input to another abstract transform.

At step 308, the method 300A may include implementing, by the processor 112, the one or more abstract pipelines as one or more packages. Each abstract transform can be implemented in numerous alternative ways. Considering, that the code base may be structured to address the abstract transforms using a unique path or a Universal Resource Identifier (URI). The abstract transforms may be implemented in packages where package names are known and imported systematically. Each transform implementation may inherit a base class that provides inherent access to parameters and data sets and handles the data set persistence. Further, each implementation may include a specified function (i.e., apply) as an entry point. Each transform implementation specifies metadata. The metadata may include at least one of, but are not limited to, URI, abstract transform name, affinity, version, schemas for abstract datasets, and the like. The URI or name of implementation may be used in the workflow configuration, the abstract transform name may be the name of the abstract transform which is implemented for the class, affinity may be a label to associate the transform to specific clusters (e.g., Central Processing Unit (CPU), Graphics Processing Unit (GPU), Tensor Processing Unit (TPU), and the like). The implementation may run only on clusters having the specified type. Further, the version may include the current version of the implementation, following major-minor-patch rule. Furthermore, schemas for the abstract datasets may include different input and output datasets variables with its schema wherever applicable. For example, the transform implementation may have been enforced it to be part of the same file as implementation in a comment block written between the magic string “%%%” depicting the start and end of metadata.

Each transform can have any number of implementations. For ‘kth’ implementation of transform, the transform implementation may be as shown in below equation 4:

$$Ik ( T ) = < \qquad Equation 4$$

$$uri : Implementation Path$$

$$trans f orm\_name : T$$

$$version : version\_string$$

$$ptype : enum \{ CPU , GPU … \}$$

$$>$$

At step 310, the method 300A may include configuring, by the processor 112, the one or more packages as a map of key-value pairs comprising keys. For example, a configuration ‘C’ corresponding to an abstract pipeline ‘P’ is simply a map of key-value pairs where the keys in ‘C’ are a superset of keys in ‘P.params.’ The configuration also specifies a mapping of each abstract transform name to a transform implementation. Such implementation may be referenced as ‘delegator/language/uri.’ Here ‘delegator’ is a string representing the backend cluster where the specific transform has to be executed, language is a string denoting the implementation language, and URI is specific to each language.

At step 312, the method 300A may include storing, by the processor 112, the configured one or more packages in a database. This may be content addressable storage. The storage may be a crucial component, because the storage enables many features for machine learning pipelines. The abstract transforms/data sets/pipelines, may be stored as abstract specifications in Yet Another Markup Language (YAML) files and check them into, for example, a Global Information Tracker (GIT) repository. The processor 112 may scan the configuration file, which may be key-value pair of parameters specified in a concrete pipeline. All such configurations are locally stored in the YAML files, which is then persisted in a centralized database or a distributed store. Further, to store and access a concrete data set, the processor 112 may associate each concrete data set with a unique hash based on its content. However, unlike the standard content-addressable storage, the processor 112 may not hash the data set after its availability. The hash is statically computed when processing the submitted pipeline before any required transforms are sent for execution.

To computed the static content hashes, consider, let ‘Tk’ be the ‘kth’ abstract transform of a pipeline and ‘Ijk’ be it's ‘jth’ implementation. Let ‘Dk’ and ‘Dk’ be the abstract output dataset and concrete output dataset respectively of ‘Tk’. ‘D0’ is the initial input concrete dataset fed to the processor 112. Let configuration ‘Ck’ be a map of key-value pairs where the keys in ‘Ck’ are a superset of keys in ‘Tk.params’. Now, the processor 112 may inductively define the hash of each concrete transform ‘Tk’ and its output concrete dataset ‘Dk’ as shown in below equations 5 and 6:

H(Tk)=Hash(Tk,Ijk,Ck,H(Dk−1)) Equation 5

H(Dk)=Hash(H(Tk),Dk) Equation 6

The unique hash of each transform enables access to task logs by storing all associated logs using the corresponding transform hash key. Note that the transform hash H(Tk) may be dependent on the output dataset hash of previous transform H(Dk−1). Also, the output dataset hash of current transform H(Dk) depends on hash of current transform H(Tk). Before hashing, the processor 112 may sort the key-value pairs of the specification and configuration in a predefined way to always generate reproducible hashes.

A concrete pipeline ‘P’ may be defined as a tuple of abstract pipeline specification along with an associated configuration <P, C >. As mentioned for abstract pipeline, ‘P.deps’ may be the dependency map of each transform's input to parent transform's output dataset. The associated pipeline hash is then calculated as shown in below equation 7:

H(P)=Hash([T1,T2, . . . ,TN],P.deps,C) Equation 7

As observed from the above equation, the hashes do not depend on any concrete outputs resulting from the execution of workflows. They can be generated using specifications, configuration, and transform metadata. Moreover, such hashes can be computed by any client device (not shown) independent of the system 110, responsible for execution as long as it has access to the source repository. Also, note that any change in any specification, configuration, or transform metadata may change the hash of the workflow.

At step 314, the method 300A may include generating, by the processor 112, an execution plan by converting the one or more abstract pipelines from the configured one or more packages into one or more concrete pipelines. Once the specifications, implementations, and configuration are available, an execution plan needs to be created. As shown in FIG. 3A, a planner CPU may utilize all these files to create an execution plan by converting abstract pipeline to concrete pipeline. The planner PL may include of dataset dependency map which maintains the dependency of concrete transforms to datasets of parent transforms, and task definition map with details of concrete transforms. The dataset dependency map provides a simpler way to resolve the dependencies of one dataset on the other via the storage layer. Because each dataset hash is a unique hash, the processor 112 may check the datasets for existence. if there is existence of datasets, the processor 112 can mark the dependency to be resolved. Once this plan is generated, it is passed to an orchestrator.

At step 316, the method 300A may include transmitting, by the processor 112, the execution plan to an orchestrator to merge individual one or more concrete pipelines into a dataset dependency graph, and to mark one or more tasks in the dataset dependency graph. As depicted in FIG. 3B, the orchestrator 320 may include three components. A server 322, may actively listens to commands from other components and the client device, maintains a queue for submitted pipelines, completed tasks, and the like. The server 322 may also maintain a list of machines in the clusters. Further, a session 324 may maintain an uber dependency graph and task information. Furthermore, a scheduler 326 may connects with spawners 328 that run the task. The orchestrator 320 may not look after about individual pipelines and merges them into an uber dataset dependency graph. After that, the orchestrator 320 marks any task with its input dataset dependency resolved for scheduling. Once the task to be scheduled is known, the orchestrator 320 may pass its corresponding information to the spawner 328. The spawner 328 may receive task information from the orchestrator 320, which calls an executor 330 depending on the task information such as language, docker configuration, storage layer, and the like. The executor 330 may include database frameworks such as for example, hive, python, R, and the like. The executor 330 may execute and save the output using a storage layer 332 and signals the completion to the spawner 328, which then signals back to the orchestrator 320. A Command Line Interface (CLI) shown in FIG. 3B may pre-process the input comprising abstract data sets. The pre-process may include, but are not limited to, handling NULL values, encoding categorical data, feature scaling, and the like.

At step 318A, the method 300A may include executing, by the processor 112, the one or more tasks as a cluster, by calling an appropriate command. Because the system 110 sits a layer above an orchestration framework, the system 110 does not need to be bound with a cluster, and it can use multiple clusters to delegate tasks in the pipeline. This removes the limitation of setting up machines exclusively for the system 110 and provides access to far endpoints. For example, the processor 112 can run a ‘spark job’ on a ‘spark cluster’ and schedule CPU-bound tasks via a ‘Kubernetes’ cluster. The system 110 may facilitate this by implementing a separate executor for each cluster, which may call the appropriate command to execute a given task, as all information for executing that task is available to an executor 330.

At step 318B, the method 300A may include obtaining, by the processor 112, one or more predictions from different models or the same model with different hyperparameters to provide a meta construct, upon executing the one or more tasks as the cluster. For Machine Learning (ML) pipelines, the processor 112 may often need to process the same data with a slight change in configuration or implementation and combine their results to obtain the final output. For example, predictions may need to be obtained from different models or the same model with different hyperparameters during ensembling. To address this, the processor 112 may define a meta construct called ‘map combine’, as shown in FIG. 3C. The map combine may be used to select the best scaling method. The map combine may be specified by three main components such as (1) Workflow Specification CY, (2) a mapper function ‘m’ generating a list of configs ‘ci,’ for given workflow specification, (3) a combiner function ‘c’ whose inputs is a list of runs ‘ri’ and generates an output. Where ‘ri,’ is running ‘S’ with config ‘ci.’ The planner PL may receive the above components to create a modified DAG. The processor 112 may execute the planner PL to output the modified DAG comprising one or more tasks mapped to the configuration. The modified DAG, as depicted in in FIG. 3C, may include tasks mapped ‘f(x)’ over the given list of configurations (also referred to as configs) and then combined towards the end with the combiner function ‘g(x)’. Here, the user 102 may need to know which scaling method gives the best results. Typically, the user 102 such as a data scientist would run three experiments and compare the results across the experiments to pick the best approach. Map combine may simplify this by creating same tasks and passing the scaling method as a configuration variable. For example, the user 102 may provide config parameter ‘scaling_method’ as a list of scaling methods to apply and define a ‘mapper_function’ that may accept the list and map it to different copies of the same task. In the end, the user 102 may write a custom logic via a combiner transform. The processor 112 may execute the combiner transform to evaluate the model outputs on a validation set and determines the scaling method that gives the best results.

The meta construct, map combine, in the system 110 may enable programmatic runs to handle scenarios such as using k-fold cross-validations for selecting one or more models, ensembling different types of the model or doing grid-based hyperparameter tuning. All the components in the system 110 may be loosely coupled and are linked together through standard message passing to share instructions and information. This allows for easily swapping or extending all the components. The loosely coupled design may provide benefits, such as language support, heterogeneous clusters, queues and policies, and backend agnostic. For the language support, the system may extract a list of transforms from the pipeline and executes the transforms separately using different executors, as discussed above. These executors are language-independent and can be easily extended to any language such as python, R, java, and the like. This provides flexibility to use cross-language tasks in the same pipeline, enabling to leverage benefits of different languages and thus providing language agility. For example, users 102 may have the choice to use statistical models provided in ‘R’ or deep learning models available in ‘python’, or use both models in an ensemble approach for the given problem. Further, the system 110 may provide support to heterogeneous clusters in different ways. The system 110 can link the affinity of a transform to the type of clusters the transform could run on. For example, all the transforms of the CPU affinity could run on CPUs while those with GPU affinity can only run-on GPUs. The system 110 may also provide the option to link executors to task-specific clusters such as, for example, Hive or Spark clusters. Hence, it could be extended to take benefits of already configured and customized clusters for specific tasks. Furthermore, the system 110 may also allow custom clusters defined concerning location, ownership, and the like, and restricts the transforms to run on those via queues. This allows the system 110 to dynamically add or subtract resources to the system 110 as per the requirements, providing platform agility.

Further, the system 110 may also incorporate different policies to manage the resources more efficiently. The orchestrator 320 may implement queues in its session to assign resources to a particular transform. This gives the flexibility to assign higher priority to a set of transforms. This can also be used to allocate custom resources to transforms as discussed above in heterogeneous clusters. In addition to this, as the pipelines are robust to data deletion, i.e., any hashed dataset can be served directly if available or can be consistently reproduced at demand, the system 110 also provides the flexibility to support different garbage cleaning policies. Users 102 can implement a policy to delete intermediate or less required transforms after a certain period without worrying about the eventual loss. This helps in managing storage resources to a great extent. It also allows to check the schema of datasets required by each transform automatically using the meta-information available of both input datasets and transforms. This makes it easier to write unit tests which can be helpful in continuous integration.

Further, although server 322 and session 324 components are required to enable different features, the system 110 can switch the scheduler 326 with any other scheduler which can schedule and execute these tasks. This can be achieved via the connector, which can convert the plan generated by the planner PL to the format the scheduler 326 understands. This provides the option to leverage all the benefits of a more advanced scheduler together, also enhancing the platform's agility.

The system 110 may use the hashing to provide a plurality of features as discussed below. Data and compute caching: as data hashes are unique to parameters used to fetch that data, they can be cached so that the system 110 does not need to fetch this data from the data store if it is already available. It also provides compute-cache by skipping over the executed transforms and directly using their available output in the next transforms. which improves the experiment's agility. Version management: in a typical machine learning problem, the user 102 has to do many experiments with different parameters or hyper-parameters, different models, and different features. This creates a problem for them to efficiently manage the experiments and save the outputs so that other experiments could not override the previous run's outputs. The system 110 provides an easy, efficient, and clean solution to these version management issues. The system 110, by default, uses all the parameters, meta information of transforms (using equation 4), and input datasets to generate hashes of output datasets. The transform meta includes a version of that transform implementation which helps in maintenance. In addition to this, transform meta also consists of the affinity, the parameters and hyper-parameters, and input-output data types, which ensure the unique hashes for each transform in the given pipeline, thus resolving the need to name the experiment outputs manually. It greatly ensures data standardization and improves experiment agility. Consistency and Reproducibility: as the output data hashes are created using the hash of transform (that generated the output) and input data hashes, the output of any transform in a given pipeline also includes information of the initial dataset and all the transforms applied till that particular transform. This ensures data consistency and guarantees that the pipeline and its configuration, including initial data information, may always generate the same outputs given fixed transform implementation. Also, as the system 110 uses git commit in the transform hashes to ensure code consistency, users can reproduce the same results of their experiments after any amount of time.

Further, the system 110 may enable human in the loop. The system 110 also provides different tools and utilities for users to quickly develop, deploy, maintain and monitor their ML models. The system 110 may include different modes. The user 102 can either work in test mode, experiment mode or deploy the model in production mode. In test mode, the user's data may be cleanly separated from each other and stored in user-specific locations. The test mode may not require the code to be committed for allowing fast testing. Once the code is fixed, the system 110 may commit the code and run the pipeline using the git commit-ids in the experiment mode to ensure the reproducibility of results. The data may be stored at one location and shared among all users in the experiment mode. Once the experiment is completed, the user 102 can then deploy the models in production to run with the latest data at a fixed time interval. The data is stored in a separate location in production mode, and the system 110 may not skip the transforms. These modes help in enhancing experiment agility while also helping in continuous deployment. The human in the loop may include a storage hierarchy. The system 110 may further ensure that the storage is separated between different modes and follows the hierarchy in dataset availability. If any dataset is required in test mode, the dataset is first searched in test storage, then in experiment storage, and finally in production storage. If the dataset is not available in the production storage, the dataset is fetched from dataset sources, otherwise, the dataset is copied from the top-level to bottom level. Further, the human in the loop may include debugging. One of the important goals of any platform is ease of debugging. For that purpose, the system 110 may provide tools to debug the pipeline running in any mode. Given the mode, pipeline, and configurations, the system 110 may fetch the plan generated by the planner to get a list of all transforms present in the pipeline. This also includes all input and output data hashes of each transform executed in that pipeline. Debug utilities then provide access to these data for analysis and give the option to run the transform by calling the corresponding executor 330. The executor 330 may provide the flexibility to the user 102 to load and execute any transform irrespective of the language. The user 102 can then debug any issue by loading the target transform and its data of the user's choice, fixing the code, and dynamically importing them to test their fixes easily. Further, the human in the loop may provide logging. The system 110 may also integrate the logging utility to save the logs inside the transforms with the timestamps via the storage layer. The logs can be easily fetched using debug utilities for any transform. The system 110 may also provide the utility to fetch logs of the entire pipeline workflow or any machine in the cluster used to run the transforms. Further, as the components of the system 110 are loosely coupled with easy access to information, the system 110 may provide flexibility to add a user interface by calling the Application Programming Interfaces (APIs) to obtain information on the status of the workflows via polling or web sockets. The user interface can also schedule pipeline workflows, group experiments, and add notes via a third-party database. Further, the system 110 may also provide the utilities to send data or metrics to a monitoring database from the transform itself. The database can then be accessed by dashboarding API to visualize it in various formats or further processed to create reports for stakeholders. For machine learning use-cases, it may be essential to ensure the quality of input datasets and validate the outputs generated. For this purpose, the system 110 may also implement the utilities to define these validations and provides the facility to send notifications on violations. The system 110 may also provide the utilities to do schema and datatype checks even before processing the pipeline.

### Exemplary Scenario 1

Consider a demand forecasting scenario for the e-commerce service provider. This is to help a data scientist in a day-to-day work and deploy models in production. In the e-commerce, there may be a need to manage millions of products and buy regularly (daily, weekly, monthly, quarterly, etc.). Furthermore, these demands must be predicted at different geographical granularities (national, zonal, regional, city, pin code) to manage storage and supply needs and make business-related decisions. The problem becomes even more complex with introducing product (super-category, category, vertical, brand) and time hierarchies (event or business-as-usual) with each time series behaving individually and as a part of different hierarchies. The system 110 may need to develop time series forecasting models to predict demand at different granularities. The models also need to account for various trend shifts and unforeseen scenarios in the real world, such as supply shocks. To overcome this, models need to run periodically and be trained with the latest data to take recent demand into account. Also, whenever a new model needs to be deployed, it has to be back casted (generating a forecast for historical time intervals) for several periods to evaluate its performance. The system 110, may provide a standardization of workflows via “no-code” YAML specifications and configurations, which may be easier for data scientists, engineers, and analysts to understand how each of the components is connected and what data is flowing in the pipeline. Further, the configurable pattern allowed the user 102 to switch between different experimental features without changing the underlying code. Further, the system 110 may provide a standardization of datasets based on specifications ensuring that data is available in a reliable fashion from any input source, including but not limited to Hive, Spark, Spreadsheets, REST APIs, and the like. Because, the input consumption is consistent across different use-cases and datasets are versioned, rollbacks to previous versions have become accessible in case of an error. Furthermore, the system 110 may provide a data caching and versioning has provided an enormous productivity boost to the data scientists. The unique content hashing may ensure reproducible results even after months of completing those experiments, enabling the user to run through experiments quickly. Compute caching (skipping the transforms whose hash remains unchanged) allowed the user to do about 10× more experiments per model due to reduced wait time. Further, the system 110 may provide a shared library of plurality of modules for feature engineering, models, and validations that is accessible to users. Moreover, this shared library is robust and war-tested for the future. Further, the system 110 may provide a language-agnostic framework provides much flexibility to users allowing them to use their language of choice to tackle sub-problems and enhance the development experience. For example, data table and dplyr in R may be extremely well-suited for data wrangling tasks. Similarly, the flexibility of modeling conventional models (ARIMA, ETS) in R and deep learning models (LSTMs-based, Wavenet-like) in python provided access to the vast community-written implementations. Furthermore, the system 110 may provide meta constructs. Due to the presence of shared library and map combine features, users have shifted to creating more complex ensemble models. This has resulted in an average of around a 3% increase in the overall prediction accuracy. Meta constructs have also made it easier to do grid-based hyper-parameter tuning. Further, the system 110 may provide debugging utilities which may help the users 102 to navigate through transforms and pipelines in the REPL of choice, providing platform emulation capabilities. This ensured reliability when productionizing models and saved time when debugging production runs. Further, the system 110 may include the UI to monitor, visualize and schedule experiments.

### Exemplary Scenario 2

At the scale of the demand-forecasting problem there may be a need for an Auto ML module to churn models on its own. The system 110 may enable creating of the Auto ML module for time-series forecasting, which is referred to as auto forecast. The Auto ML inherently may require three aspects. First, a process to specify a pipeline; second, a system that can understand the pipelines it submits and evaluate them; and third, a system that can compile the results and return the results. The system 110 may enable plug-and-play any Auto ML algorithm which can create, rank, and select the best pipelines. The Auto ML may also provide standardization of workflows/data sets, shared library of transforms, language-agnostic framework, and version management. Other benefits through which the system 110 facilitates the development of an AutoML system, may include as discussed below. Parallelism: auto forecast can easily plug and play transforms to generate pipelines which the system 110 understands, which is as simple as generating a configuration YAML file that the system 110 can interpret. The auto forecast can create pipelines without executing the pipelines in real-time. The auto forecast cuts down on extensive waiting times, which Auto ML modules observe. Run-time statistics: a general point of concern of any Auto ML module is that, the Auto ML may create complex with slight/no improvement in the final metrics. As the system 110 may also capture run-time statistics such as the CPU usage, memory, running-time of transforms, and pipelines, the auto forecast can easily fetch and incorporate these run-time features in the algorithm to select simpler pipelines with similar accuracy. Access to the past incremental corpus: the system 110 may create a repository of all past applied transforms, the run-time statistics, and overall performance of the pipeline. The auto-forecast algorithm may include access to the ever-increasing historical data. Using the corpus of past behaviors and observations, the auto forecast can better learn which transforms should be applied at which stage and for which dataset, eventually generating a better pipeline for an unseen problem.

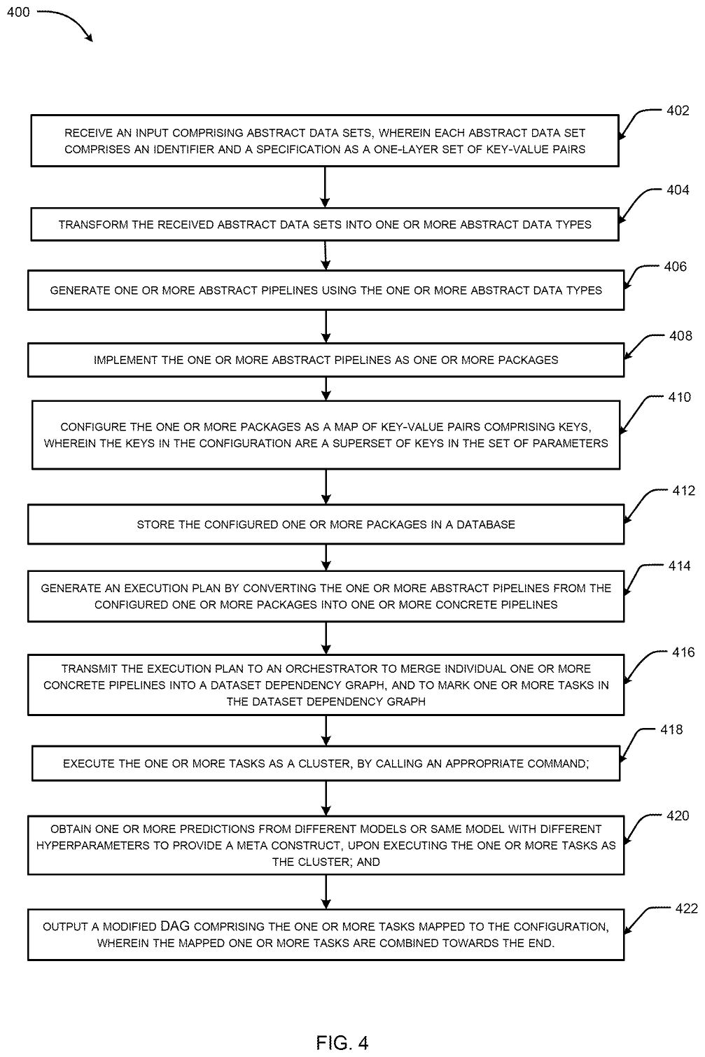

FIG. 4 illustrates a flow chart depicting a method 400 of managing reproducible machine learning workflows, according to embodiments of the present disclosure.

At block 402, the method 400 includes, receiving, by a processor 112 associated with the workflow management system 110 (i.e., system 210), an input comprising abstract data sets. Each abstract data set comprises an identifier and a specification as a one-layer set of key-value pairs.

At block 404, the method 400 includes transforming, by the processor 112, the received abstract data sets into one or more abstract data types. Each abstract data type comprises a set of parameters specified as key-value pairs of variable names and associated abstract data types.

At block 406, the method 400 includes generating, by the processor 112, one or more abstract pipelines using the one or more abstract data types. The one or more abstract pipelines are machine learning workflows. The one or more abstract pipelines comprise similar specifications of the abstract data types and a Directed Acyclic Graph (DAG).

At block 408, the method 400 includes implementing, by the processor 112, the one or more abstract pipelines as one or more packages. The one or more packages comprise pre-defined names and are imported systematically.

At block 410, the method 400 includes configuring, by the processor 112, the one or more packages as a map of key-value pairs comprising keys. The keys in the configuration are a superset of keys in the set of parameters.

At block 412, the method 400 includes storing, by the processor 112, the configured one or more packages in a database. The one or more packages are stored upon checking in a repository and storing locally as files.

At block 414, the method 400 includes generating, by the processor 112, an execution plan by converting the one or more abstract pipelines from the configured one or more packages into one or more concrete pipelines.

At block 416, the method 400 includes transmitting, by the processor 112, the execution plan to an orchestrator to merge individual one or more concrete pipelines into a dataset dependency graph, and to mark one or more tasks in the dataset dependency graph.

At block 418, the method 400 includes executing, by the processor 112, the one or more tasks as a cluster, by calling an appropriate command.

At block 420, the method 400 includes obtaining, by the processor 112, one or more predictions from different models or same model with different hyperparameters to provide a meta construct, upon executing the one or more tasks as the cluster.

At block 422, the method 400 includes outputting, by the processor 112, a modified DAG comprising the one or more tasks mapped to the configuration. The mapped one or more tasks are combined towards the end

The order in which the method 400 are described is not intended to be construed as a limitation, and any number of the described method blocks may be combined or otherwise performed in any order to implement the method 400 or an alternate method. Additionally, individual blocks may be deleted from the method 400 without departing from the spirit and scope of the present disclosure described herein. Furthermore, the method 400 may be implemented in any suitable hardware, software, firmware, or a combination thereof, that exists in the related art or that is later developed. The method 400 describe, without limitation, the implementation of the system 210. A person of skill in the art will understand that method 400 may be modified appropriately for implementation in various manners without departing from the scope and spirit of the disclosure.

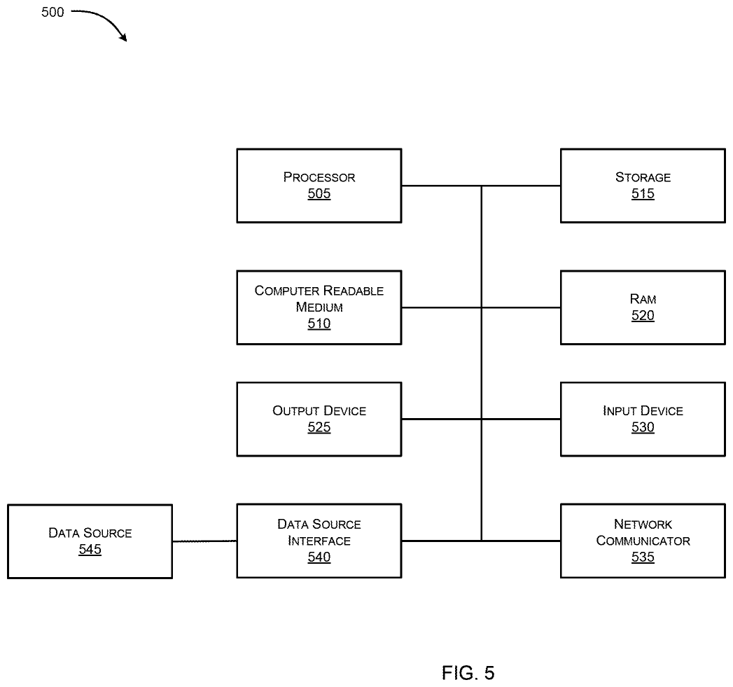

FIG. 5 illustrates a hardware platform 500 for implementation of the disclosed system 110, according to an example embodiment of the present disclosure. For the sake of brevity, construction and operational features of the system 110 which are explained in detail above are not explained in detail herein. Particularly, computing machines such as but not limited to internal/external server clusters, quantum computers, desktops, laptops, smartphones, tablets, and wearables which may be used to execute the system 110 or may include the structure of the hardware platform 500. As illustrated, the hardware platform 500 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 500 may be a computer system such as the system 110 that may be used with the embodiments described herein. The computer system may represent a computational platform that includes components that may be in a server or another computer system. The computer system may execute, by the processor 505 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and documents and analyze documents. In an example, the modules 204, may be software codes or components performing these steps.

The instructions on the computer-readable storage medium 510 are read and stored the instructions in storage 515 or in random access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interacting with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for instance. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as a limitation.

### Advantages of the Present Disclosure

The present disclosure provides a method and a system for managing reproducible machine learning workflows.

The present disclosure provides experiment agility based on caching executed task outputs to help users do similar experiments quickly.

The present disclosure provides a platform/language agility by running pipelines while being agnostic to language.

The present disclosure provides a Machine Learning (ML) meta construct such as vertical/horizontal stacking, hyperparameter tuning, back casting (for time series), and the like.

The present disclosure provides a reproducibility and data standardization, by creating, maintaining, deleting the data generated at various stages, and maintaining implementation versions to track and reproduce results.

The present disclosure provides ease of debugging by allowing the users to modify a part of some tasks and run dependent tasks only instead of running the whole pipeline from the beginning. Even for the produced pipelines, logs and the intermediate data are available to users for debugging.

The present disclosure provides continuous integration and deployment, based on checking the feasibility and testing automatically before merging new changes or allowing reverting back to the previous deployment in case of any issues.

We claim:

1. A method for managing reproducible machine learning workflows, the method comprising:
receiving, by a processor associated with a workflow management system, an input comprising abstract data sets, wherein each abstract data set comprises an identifier and a specification as a one-layer set of key-value pairs;
transforming, by the processor, the received abstract data sets into one or more abstract data types, wherein each abstract data type comprises a set of parameters specified as key-value pairs of variable names and associated abstract data types along with a map of input abstract data sets and output abstract data sets;
generating, by the processor, one or more abstract pipelines using the one or more abstract data types, wherein the one or more abstract pipelines are machine learning workflows, and wherein the one or more abstract pipelines comprise similar specifications of the abstract data types and a Directed Acyclic Graph (DAG);
implementing, by the processor, the one or more abstract pipelines as one or more packages, wherein the one or more packages comprise pre-defined names and are imported systematically;
configuring, by the processor, the one or more packages as a map of key-value pairs comprising keys, wherein the keys in the configuration are a superset of keys in the set of parameters;
storing, by the processor, the configured one or more packages in a database, wherein the one or more packages are stored upon checking in a repository and storing locally as files;
generating, by the processor, an execution plan by converting the one or more abstract pipelines from the configured one or more packages into one or more concrete pipelines;
transmitting, by the processor, the execution plan to an orchestrator to merge individual one or more concrete pipelines into a dataset dependency graph, and to mark one or more tasks in the dataset dependency graph;
executing, by the processor, the one or more tasks as a cluster, by calling an appropriate command;
obtaining, by the processor, one or more predictions from different models or same model with different hyperparameters to provide a meta construct, upon executing the one or more tasks as the cluster; and
outputting, by the processor, a modified DAG comprising the one or more tasks mapped to the configuration, wherein the mapped one or more tasks are combined together using a combiner function.

2. The method as claimed in claim 1, wherein the abstract data sets, the one or more abstract pipelines comprises the specification, and wherein the one or more concrete pipelines comprise implementation.

3. The method as claimed in claim 1, wherein the configuration specifies a mapping of each one or more abstract data types to implementation of the one or more abstract pipelines.

4. The method as claimed in claim 1, wherein, each implementation of the one or more abstract pipelines as one or more packages inherits a base class to provide inherent access to the set of parameters and the abstract data sets and handle storage of the abstract data sets.

5. The method as claimed in claim 1, wherein each transformation of the received abstract data sets into the one or more abstract data types comprises metadata, wherein the metadata comprises at least one of, a Uniform Resource Identifier (URI), an abstract transform name, an affinity, versions, and schemas for the abstract data sets.

6. The method as claimed in claim 1, wherein the one or more abstract pipelines are an extension of the transformation.

7. The method as claimed in claim 1, wherein the DAG comprises nodes, wherein the nodes are the transformation specified by a name mapped to the one or more abstract data types.

8. The method as claimed in claim 1, wherein the meta construct comprises at least one of a workflow specification, a mapper function, and the combiner function, wherein the mapper function is to generate a list of configurations for the workflow specification, and the combiner function comprises receiving a list of runs for a list of configurations and generating an output.

9. The method as claimed in claim 1, wherein the one or more concrete pipelines comprises a dataset dependency map which comprises a dependency of concrete data types to concrete datasets of parent concrete data types, and a task definition map with information of concrete data types.

10. The method as claimed in claim 1, wherein the orchestrator comprises three components, which comprises a server to actively listen to commands from other components and a client, to maintain a queue for submitted the one or more abstract pipelines, completed tasks, to maintain a list of machines in the clusters, a session manager to maintain the dependency graph and task information, a scheduler to connect with spawners that run the tasks.

11. The method as claimed in claim 1, wherein upon executing the one or more tasks as the cluster, the orchestrator transmits task information to a spawner, wherein the spawner receives task information from the orchestrator and calls an executor depending on the task information, wherein the executor executes and saves the output and signals completion to the spawner, and wherein the spawner signals back to the orchestrator.

12. A workflow management system for managing reproducible machine learning workflows, the system comprising:
a processor;
a memory coupled to the processor, wherein the memory comprises processor-executable instructions, which on execution, causes the processor to:
receive an input comprising abstract data sets, wherein each abstract data set comprises an identifier and a specification as a one-layer set of key-value pairs;
transform the received abstract data sets into one or more abstract data types, wherein each abstract data type comprises a set of parameters specified as key-value pairs of variable names and associated abstract data types along with a map of input abstract data sets and output abstract data sets;
generate one or more abstract pipelines using the one or more abstract data types, wherein the one or more abstract pipelines are machine learning workflows, and wherein the one or more abstract pipelines comprise similar specifications of the abstract data types and a Directed Acyclic Graph (DAG);
implement the one or more abstract pipelines as one or more packages, wherein the one or more packages comprise pre-defined names and are imported systematically;
configure the one or more packages as a map of key-value pairs comprising keys, wherein the keys in the configuration are a superset of keys in the set of parameters;
store the configured one or more packages in a database, wherein the one or more packages are stored upon checking in a repository and storing locally as files;
generate an execution plan by converting the one or more abstract pipelines from the configured one or more packages into one or more concrete pipelines;
transmit the execution plan to an orchestrator to merge individual one or more concrete pipelines into a dataset dependency graph, and to mark one or more tasks in the dataset dependency graph;
execute the one or more tasks as a cluster, by calling an appropriate command;
obtain one or more predictions from different models or same model with different hyperparameters to provide a meta construct, upon executing the one or more tasks as the cluster; and
output a modified DAG comprising the one or more tasks mapped to the configuration, wherein the mapped one or more tasks are combined together using a combiner function.

13. The workflow management system as claimed in claim 12, wherein the abstract data sets, the one or more abstract pipelines comprises the specification, and wherein the one or more concrete pipelines comprise implementation.

14. The workflow management system as claimed in claim 12, wherein the configuration specifies a mapping of each one or more abstract data types to implementation of the one or more abstract pipelines.

15. The workflow management system as claimed in claim 12, wherein, each implementation of the one or more abstract pipelines as one or more packages inherits a base class to provide inherent access to the set of parameters and the abstract data sets and handle storage of the abstract data sets.

16. The workflow management system as claimed in claim 12, wherein each transformation of the received abstract data sets into the one or more abstract data types comprises metadata, wherein the metadata comprises at least one of, a Uniform Resource Identifier (URI), an abstract transform name, an affinity, versions, and schemas for the abstract data sets.

17. The workflow management system as claimed in claim 12, wherein the one or more abstract pipelines are an extension of the transformation.

18. The workflow management system as claimed in claim 12, wherein the DAG comprises nodes, wherein the nodes are the transformation specified by a name mapped to the one or more abstract data types.

19. The workflow management system as claimed in claim 12, wherein the meta construct comprises at least one of a workflow specification, a mapper function, and the combiner function, wherein the mapper function is to generate a list of configurations for the workflow specification, and the combiner function comprises receiving a list of runs for a list of configurations and generating an output.

20. The workflow management system as claimed in claim 12, wherein the one or more concrete pipelines comprises a dataset dependency map which comprises a dependency of concrete data types to concrete datasets of parent concrete data types, and a task definition map with information of concrete data types.

21. The workflow management system as claimed in claim 12, wherein the orchestrator comprises three components, which comprises a server to actively listen to commands from other components and a client, to maintain a queue for the one or more abstract pipelines, completed tasks, to maintain a list of machines in the clusters, a session manager to maintain the dependency graph and task information, a scheduler to connect with spawners that run the tasks.

22. The workflow management system as claimed in claim 12, wherein upon executing the one or more tasks as the cluster, the orchestrator transmits task information to a spawner, wherein the spawner receives task information from the orchestrator and calls an executor depending on the task information, wherein the executor executes and saves the output and signals completion to the spawner, and wherein the spawner signals back to the orchestrator.
